(19) United States
(12) Patent Application Publication
(10) Pub. No.: US 2006/0223357 A1
(43) Pub. Date: Oct. 5, 2006

(54) Electric connector plug with lock screws

(76) Inventors: Yasuo Ohki, Tokyo (JP); Yasuo Omori, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 11/389,165

(22) Filed: Mar. 27, 2006

(30) Foreign Application Priority Data
Mar. 30, 2005 (JP) 2005-097957

(51) Int. Cl. H01R 13/627

(52) U.S. Cl. 439/362

(57) ABSTRACT

To form an earth course to ground in a metal shell of an electric connector plug with lock screws to have a simple structure of a connector housing and secure and durable performance, the connector plug includes an insulative connector housing having a rectangular body on which contacts are arranged, and locking sections extending out to two lateral portions of the body, metal lock screws inserted through screw holes formed in the locking sections, and a metal shell for electrically covering the connector housing; wherein the shell covers the locking sections, and through-holes for inserting the lock screws are formed in the shell in positions facing the screw holes, and a contact surface to which the relevant lock screw partially contacts is secured for electric shield around one side of each of the through-holes.

### BACKGROUND OF THE INVENTION

1. Field of the Invention

The present invention relates to a plug for an electric connecter with lock screws, for example, configured in a way that a connection condition is firmly maintained by screw clamping.

2. Related Art

In an electric connecter having a metal shell for a measure against EMI used for connection of a personal computer, LAN device, measuring instrument and the like, an insulative connector housing is covered with a metal shell for measures for electric shield, and electrical connection between respective shells at a receptacle side and a plug side of the electrical connector is established by directly contacting parts of the shells to each other. As a receptacle mounted on a printed circuit board, a receptacle is known, in which a metal shell is electrically connected by a screw, to a conductive nut fitted in a through-hole of a housing body of the receptacle and a metal sheet member, and when the receptacle is mounted on the printed circuit board, the shell is earthed to a conductive portion of the relevant printed circuit board (refer to JP-U-5-72069).

However, since a plug to be connected to the receptacle for the electrical connector is of a structure where the electric connection is established by contacting the shells to each other when contacts are engaged with each other, an electrical connection condition of the plug is not necessarily secure, and may deteriorate due to aging. Furthermore, even in a type of an electrical connector with a lock screw, while mechanical connection between the receptacle and the plug is secure and firm by the screw and a nut, connection between respective shells of the receptacle and the plug for the measures for electric shield is made by partially butting the relevant shells to each other, which is insufficient in secureness.

### SUMMARY OF THE INVENTION

In view of the above problems in the conventional plug, an object of the invention is to provide an electric connector plug with lock screws in which in the receptacle and the plug of the electric connector, a secure electric conduction path can be ensured in addition to an electric conduction path by direct contact between the shells for covering the connector housings.

Thus, an electric connector plug with lock screws according to the invention is configured to include an insulative connector housing having a rectangular body on which contacts are arranged, and locking sections extending out to two lateral portions of the body, metal lock screws inserted through screw holes formed in the locking sections, and a metal shell for electrically covering the connector housing; wherein the shell covers the locking sections, and through-holes for inserting the lock screws are formed in the shell in positions facing the screw holes, and a contact surface to which the relevant lock screw partially contacts is secured for electric shield around one side of each of the through-holes.

The screw holes in the locking sections are preferably configured in a way that when the lock screws are inserted through the holes, front ends of the lock screws act as taps to form thread grooves.

According to the electric connector plug with lock screws of the invention, once the relevant electric connector plug with lock screws is fitted in an electric connector receptacle as the other connector and thus connected to the receptacle, and the lock screws are clamped in nuts at a side of the receptacle, the shell covering the body contacts to a shell of the electric connector receptacle and thus electrically conducted thereto, and firm connection is achieved through clamping the lock screws with the nuts at the receptacle side. The lock screws are clamped respectively in the locking sections of the connector plug, thereby a part of the relevant lock screw such as an end face of a grip of the lock screw or washer tightly contacts to a contact surface around a through-hole of the shell that covers a front side of the locking section, and consequently the shell, lock screw, and nut at the receptacle side are electrically conducted. The shell at the receptacle side is electrically conducted to the nut, and the shell at the plug side is electrically conducted to the shell at the receptacle side therethrough. The shell at the receptacle side is earthed to ground of a printed circuit board, and the whole electric connector including the plug and the receptacle is electrically shielded therethrough.

In this way, for the receptacle and the plug for the electric connector, a secure electric conduction path is newly ensured by the lock screw and the nut in addition to the electric conduction path by direct contact between the shells for covering the connector housings.

### BRIEF DESCRIPTION OF THE DRAWINGS

FIGS. 1A, 1B, 1C and 1D are plane, front, back and right side views showing respectively an electric connector plug with lock screws according to an embodiment of the invention;

FIGS. 2A, 2B, 2C, 2D and 2E are plane, front, back, right side and bottom views showing respectively a connector housing of the electric connector plug with lock screws;

FIGS. 3A, 3B, 3C, 3D and 3E are plane, front, back, right side and bottom views showing an upper shell of the electric connector plug with lock screws;

FIG. 4A, 4B, 4C, 4D and 4E are plane, front, back, right side and bottom views showing respectively a lower shell of the electric connector plug with lock screws;

FIG. 5A, 5B, 5C, 5D and 5E are plane, front, back, right side and bottom views showing respectively a condition where the upper and lower shells are attached to the connector housing;

FIG. 6 is a cross section view along a line 6-6 in FIG. 5A;

FIG. 7A is a cross section view partially showing an aspect that the electric connector plug with lock screws is subjected to insert-molding;

FIG. 7B is a cross section view of the connector plug after the molding;

FIG. 8 is a cross section view showing a use situation of the electric connector plug with lock screws;

FIG. 9 is a cross section view partially showing the use situation of the electric connector plug with lock screws; and

FIG. 10 is a cross section view showing a use situation of a electric connector plug with lock screws according to another embodiment.

### DETAILED DESCRIPTION OF THE PREFERRED EMBODIMENTS

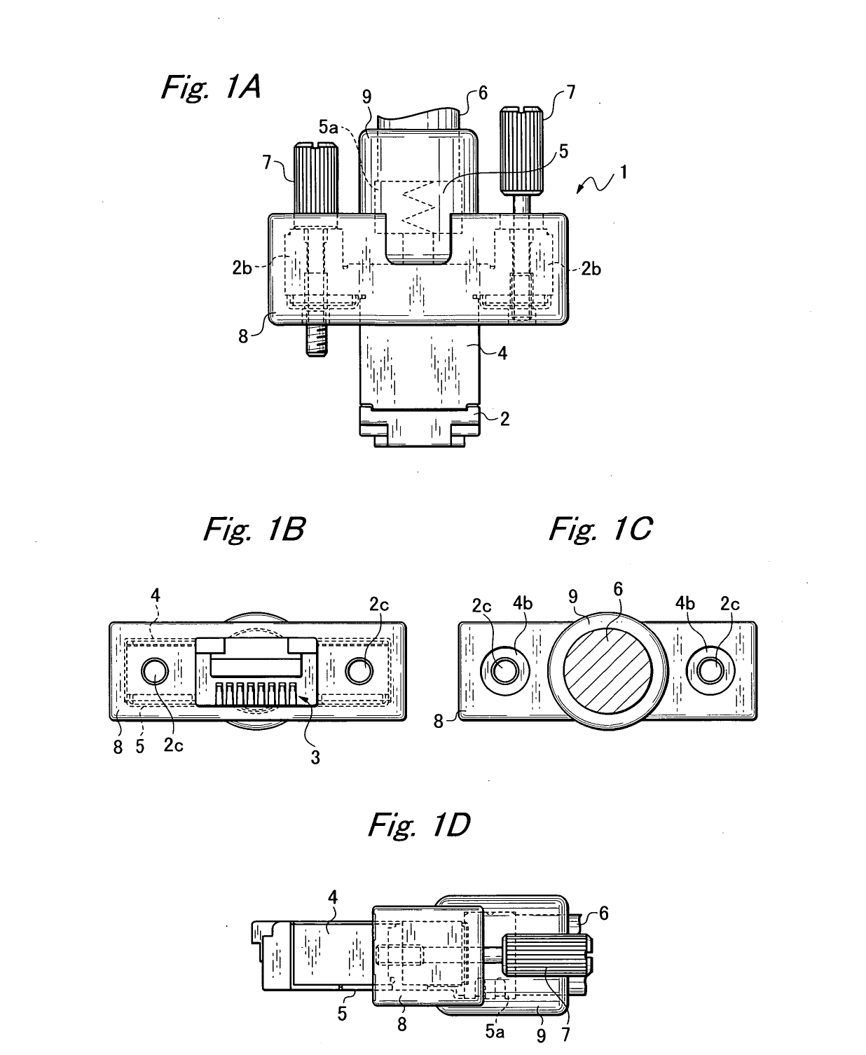

As shown in FIG. 1A to FIG. 1D, an electric connector plug with lock screws 1 according to an embodiment of the invention generally includes an insulative synthetic-resin connector housing 2; a plurality of contacts 3 lined on the connector housing 2; an upper shell 4 and a lower shell 5 for electrically covering the connector housing 2; a cable 6 having a shielded wire (braded net wire) that is folded back to the outside of the cable and then fixed to a clasp 5a of the lower shell 5 by calking; metal lock screws 7 inserted through screw holes 2c provided in locking sections 2b in lateral portions of the connector housing 2; and a housing cover 8 and a cable cover 9, which are formed by insert molding such that they partially cover the locking sections 2b and the upper and lower shells 4 and 5, and cover an end portion of the cable 6.

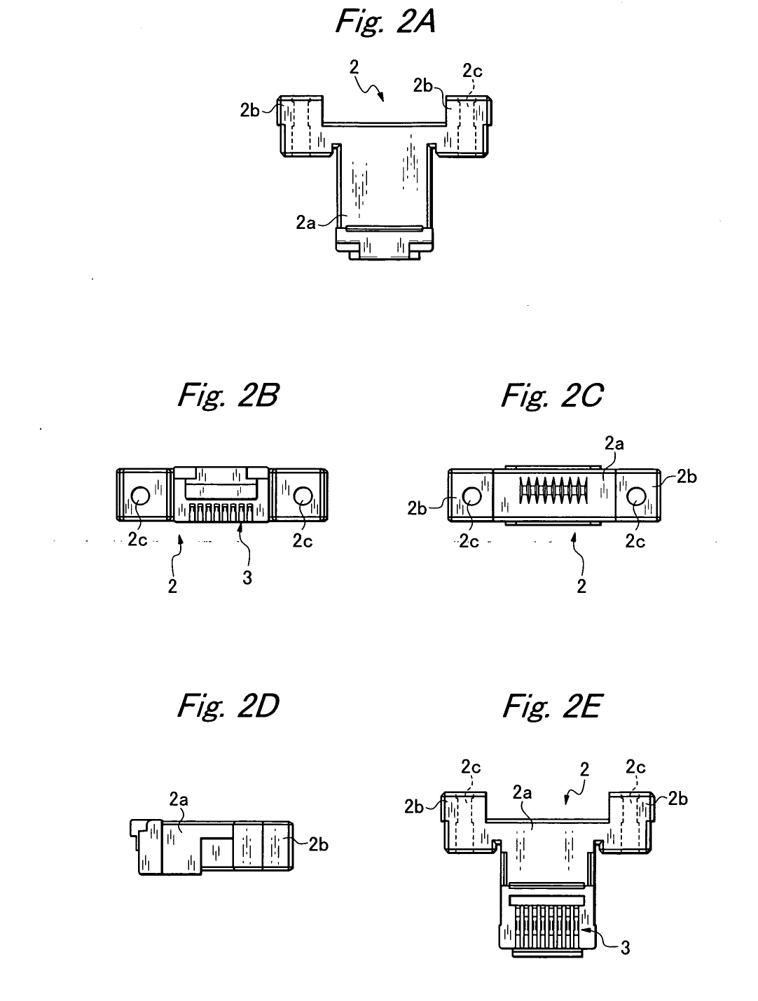

As shown in FIGS. 2A to 2E, the connector housing 2 has a central, rectangular body 2a, and locking sections 2b extending out from rear ends of the body to both sides. A front end of the body 2a is a portion to be attached to a fitting portion of a receptacle as the other connector, on which contacts 3 for connection are disposed parallel to one another. In the locking sections 2b, screw holes 2c running through the sections in a back and forth direction are formed respectively. A portion having a reduced hole-diameter is formed at a rear end side of the screw hole 2c, and when a metal lock screw 7 is first inserted through the screw hole 2c, a front end of the lock screw acts as a tap to form a thread groove. Therefore, after the lock screw 7 is screwed into the screw hole 2c and then inserted through the hole, it is retained and held by the relevant lock screw hole 2c.

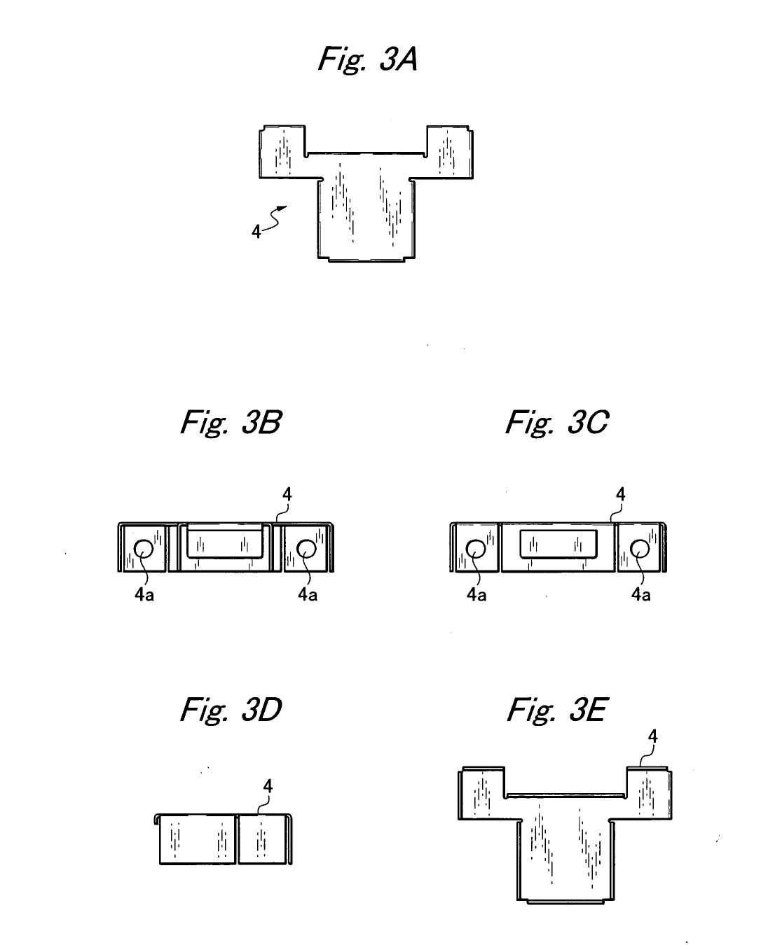

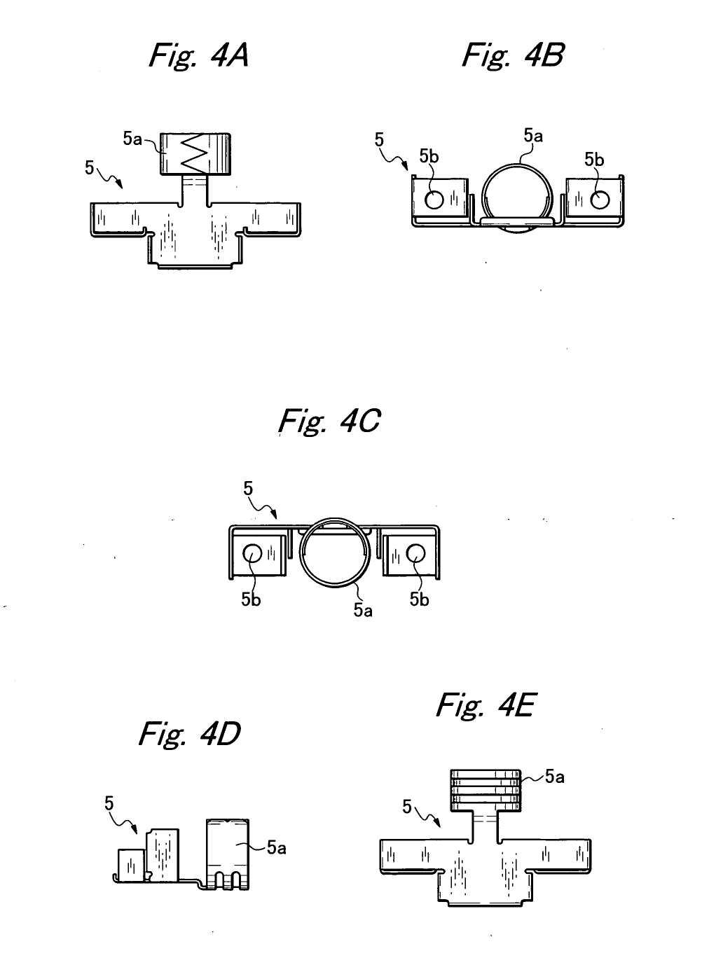

The upper shell 4 and the lower shell 5 cover the body 2a and the locking sections 2b of the connector housing 2, and integrally molded as shown in FIG. 3A to FIG. 4E. Holes 4a and 5b for inserting the lock screws 7 are formed in portions for covering the locking sections 2b respectively.

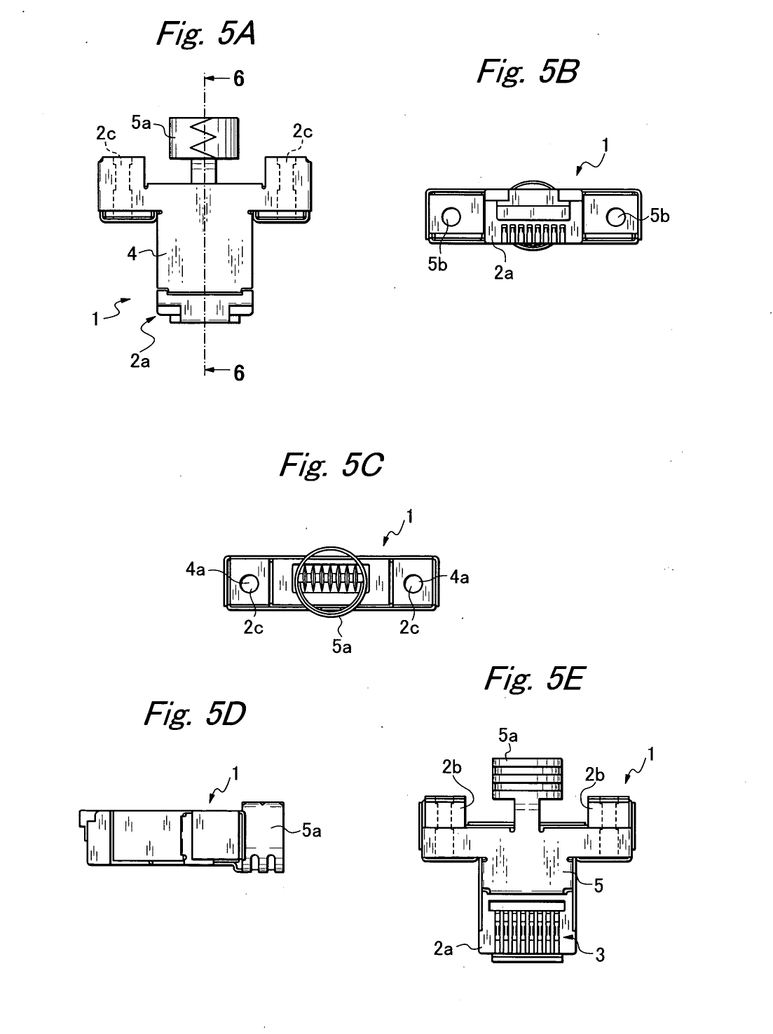

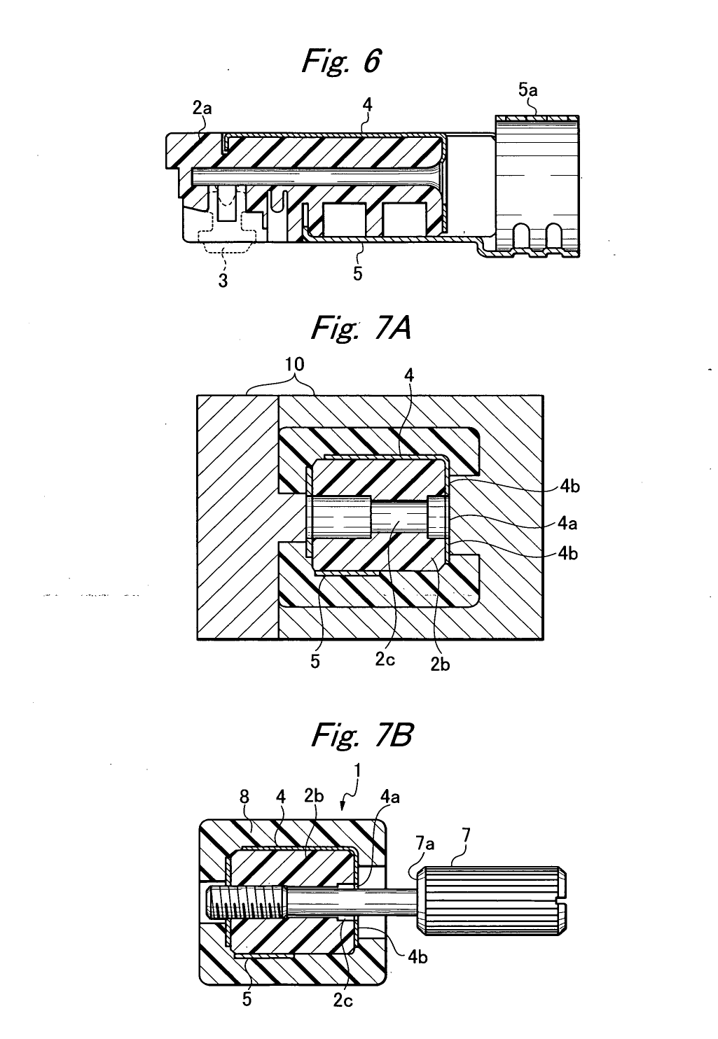

As shown in FIG. 5A to FIG. 6, the upper shell 4 and the lower shell 5 are attached to the connector housing 2 to cover the housing, and then the cable 6, each of element wires of which was connected to each of the contacts 3, is run through the clasp 5a of the lower shell 5, and then the braded net wire for shield is folded back to the outside and then fixed to the clasp by calking.

Next, the connector plug 1 in a condition where the shells 4, 5 and the cable 6 are attached to the connector housing 2 is disposed in a die 10 as shown in FIG. 7A. At that time, the die 10 is designed such that the screw hole 2c and the hole 4a are not plugged in the locking section 2b of the connector housing 2, and a contact surface 4b is secured around the hole 4a so that an end face 7a of a grip of a lock screw 7 can contact to an extended portion of the upper shell 4.

In addition to this, a case that the contact surface 4b is secured by a spring strip folded inside the hole 4a is also acceptable. In this case, part of the lock screw 7 may include a flange integrated with the lock screw, or a separate washer, pipe or the like fitted with the relevant lock screw.

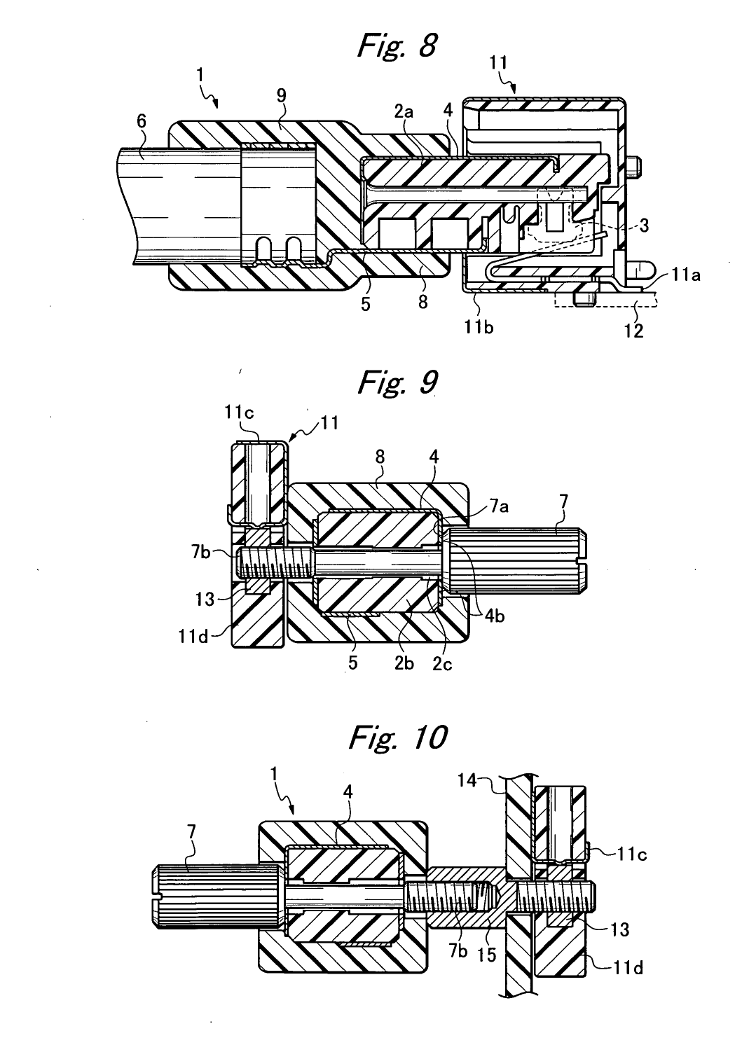

Then, melted resin is flown into a cavity of the die to form a housing cover 8 and a cable cover 9. In this way, the electric connector plug with lock screws 1 is completed. In usage of the plug 1, as shown in FIG. 8, for example, the plug is connected to a connector receptacle 11 as the other connector in a modular type, wherein the contact 3 of the plug 1 is connected to the contact 11a at a receptacle side, and the shells 4, 5 at a plug 1 side contact to a shell 11b and the like at the receptacle 11 side and thus connected thereto, and consequently earthed to ground of a printed circuit board 12 on which the receptacle 11 is mounted.

Furthermore, as shown in FIG. 9, the lock screw 7 is clamped to a lock nut 13 of the receptacle as the other connector, thereby the end face 7a of the grip firmly contacts to the contact surface 4b of the upper shell 4, and the front end 7b of the lock screw is connected to a nut 13 of a locking section 11d at the receptacle side, and the nut 13 contacts to a shell 11c at the receptacle side and thus connected thereto, as a result the shell 4 is electrically conducted to the shell 11c, resulting in formation of electric shield. In this way, in addition to a shield path by direct contact between the shells 4 and 11c, a shield path via the lock screw 7 and the nut 13 is formed, which guarantees secureness. When a panel 14 is interposed between the plug and the receptacle as shown in FIG. 10, an offset screw 15 is preferably disposed at a front-end side of the lock screw 7 for screw clamping. Thus, a new shield path is secured by the lock screw 7 and the nut 13 as in the case of FIG. 9.

What is claimed is:

1. An electric connector plug with lock screws comprising,
an insulative connector housing having a rectangular body on which contacts are arranged, and locking sections extending out to two lateral portions of the body,
metal lock screws inserted through screw holes formed in the locking sections, and
a metal shell for electrically covering the connector housing;
wherein the shell covers the locking sections, and through-holes for inserting the lock screws are formed in the shell in positions facing the screw holes, and a contact surface to which the relevant lock screw partially contacts is secured for electric shield around one side of each of the through-holes.

2. An electric connector plug with lock screws according to claim 1, wherein the screw holes in the locking sections are configured in a way that when the lock screws are inserted through the holes, front ends of the lock screws act as taps to form thread grooves in the holes.
